(19) United States
(12) Patent Application Publication
(10) Pub. No.: US 2024/0204841 A1
(43) Pub. Date: Jun. 20, 2024

(54) FREQUENCY SELECTIVITY BASED CQI AND PMI REPORTING

(71) Applicant: QUALCOMM Incorporated, San Diego, CA (US)

(72) Inventors: Ahmed Attia ABOTABL, San Diego, CA (US); Yu ZHANG, San Diego, CA (US); Ahmed ELSHAFIE, San Diego, CA (US); Muhammad Sayed Khairy ABDELGHAFFAR, San Jose, CA (US)

(21) Appl. No.: 18/066,268

(22) Filed: Dec. 14, 2022

(51) Int. Cl. H04B 7/06; H04L 5/00; H04W 72/02; H04W 72/0457

(52) U.S. Cl. CPC H04B 7/0626; H04B 7/0632; H04L 5/0051; H04W 72/02; H04W 72/0457

(57) ABSTRACT

A network node may transmit a CSI-RS to a UE. The UE may transmit a CSI report corresponding to at least one UE-selected bandwidth portion of a downlink BWP to the network node based on the CSI-RS. The CSI report may include at least one CQI for the at least one UE-selected bandwidth portion of the downlink BWP. The downlink BWP may be associated with a full-duplex operation.

### TECHNICAL FIELD

The present disclosure relates generally to communication systems, and more particularly, to channel state information (CSI) reporting in a full-duplex wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive a CSI-reference signal (CSI-RS) from a network node. The apparatus may transmit a CSI report corresponding to at least one UE-selected bandwidth portion of a downlink bandwidth part (BWP) to the network node based on the CSI-RS.

In an aspect of the disclosure, a method, a computer-readable medium, and an apparatus are provided. The apparatus may be a network node. The apparatus may transmit a CSI-RS to a UE. The apparatus may receive a CSI report corresponding to at least one UE-selected bandwidth portion of a downlink BWP from the UE based on the CSI-RS.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates a first example and a second example of in-band full-duplex (IBFD) resources and a third example of sub-band full-duplex (SBFD) resources.

FIG. 5 is a diagram illustrating various example deployment scenarios including one or more full-duplex devices.

FIG. 6 is a diagram illustrating an example slot format of an example SBFD slot.

FIG. 7 is a diagram illustrating examples scenarios where a UE may experience interference.

FIG. 8 is a diagram of a communication flow of a method of link adaptation.

FIG. 9 is a diagram illustrating an example CSI framework for dynamic antenna port adaptation.

FIG. 10 is a diagram illustrating example sub-band channel quality indicator (CQI) reporting according to one or more aspects.

FIG. 11 is a diagram of a communication flow of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

If the channel does not experience significant frequency selectivity, the sub-band (or “subband”) CQI offset from the wideband CQI (e.g., the wideband may correspond to an entire downlink BWP) may be zero or close to zero for most of the sub-bands. Both differential sub-band CQI reporting and absolute sub-band CQI reporting may be associated with reporting overhead (e.g., 2 bits for the differential reporting and 4 bits for the absolute reporting). However, if the channel has low frequency selectivity (i.e., the channel condition does not vary significantly across the spectrum), the bits used for the sub-band CQI reporting may be redundant.

According to one or more aspects, a network node may transmit a CSI-RS to a UE. The UE may transmit a CSI report corresponding to at least one UE-selected bandwidth portion of a downlink BWP to the network node based on the CSI-RS. Accordingly, CSI overhead may be reduced. Further, less sub-band CQI and/or precoding matrix indicator (PMI) processing at the UE may be performed, which may lead to less power consumption at the UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

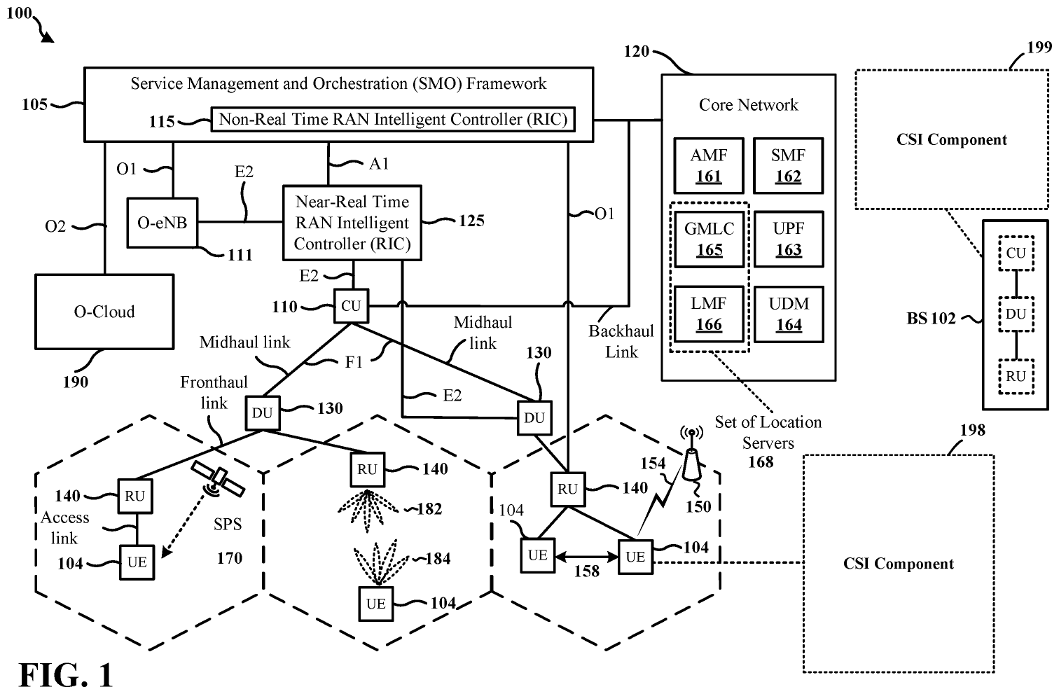

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like.

Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a CSI component 198 that may be configured to receive a CSI-RS from a network node. The CSI component 198 may be configured to transmit a CSI report corresponding to at least one UE-selected bandwidth portion of a downlink BWP to the network node based on the CSI-RS. In certain aspects, the base station 102 may include a CSI component 199 that may be configured to transmit a CSI-RS to a UE. The CSI component 199 may be configured to receive a CSI report corresponding to at least one UE-selected bandwidth portion of a downlink BWP from the UE based on the CSI-RS. Although the following description may be focused on 5G NR, the concepts described herein may be applicable to other similar areas, such as LTE, LTE-A, CDMA, GSM, and other wireless technologies.

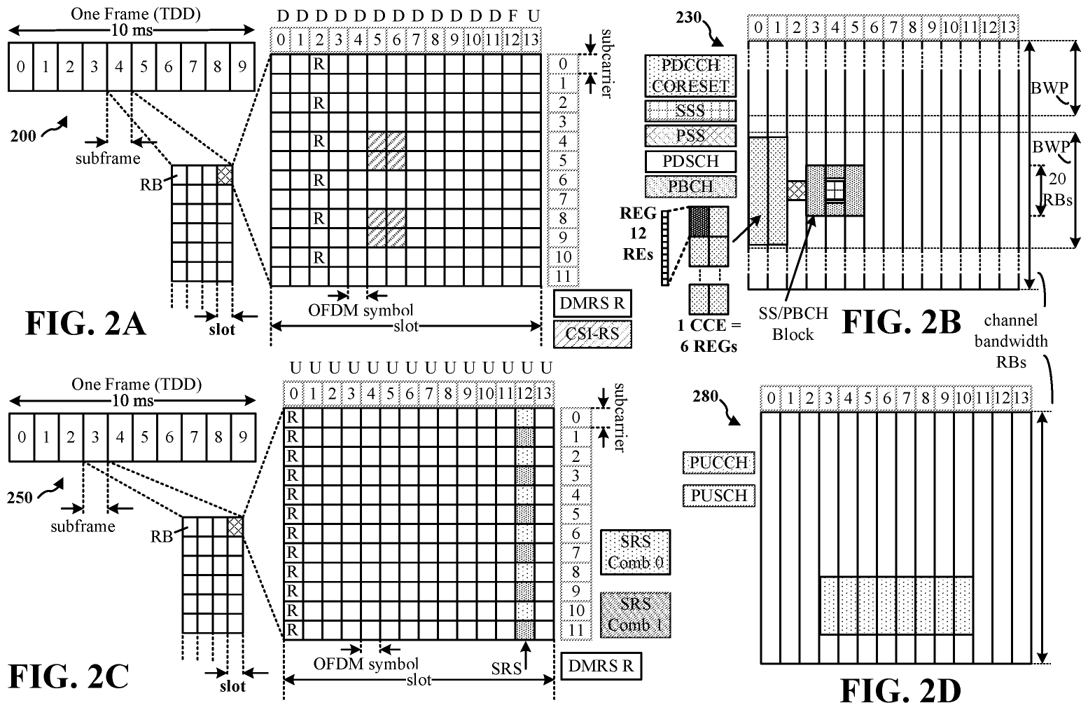

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2μ*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

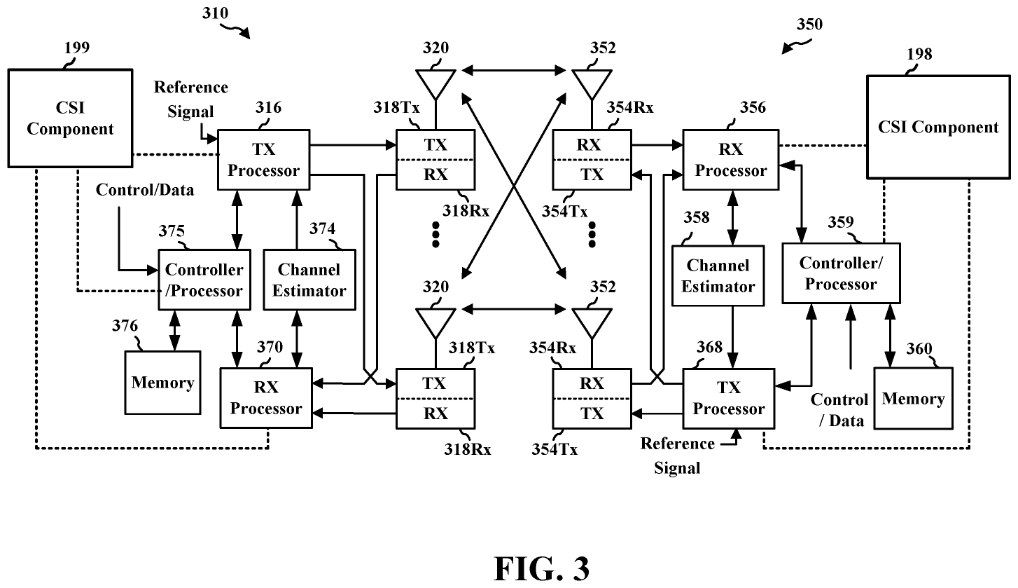

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CSI component 198 of FIG. 1.

At least one of the TX processor 316, the RX processor 370, and the controller/processor 375 may be configured to perform aspects in connection with the CSI component 199 of FIG. 1.

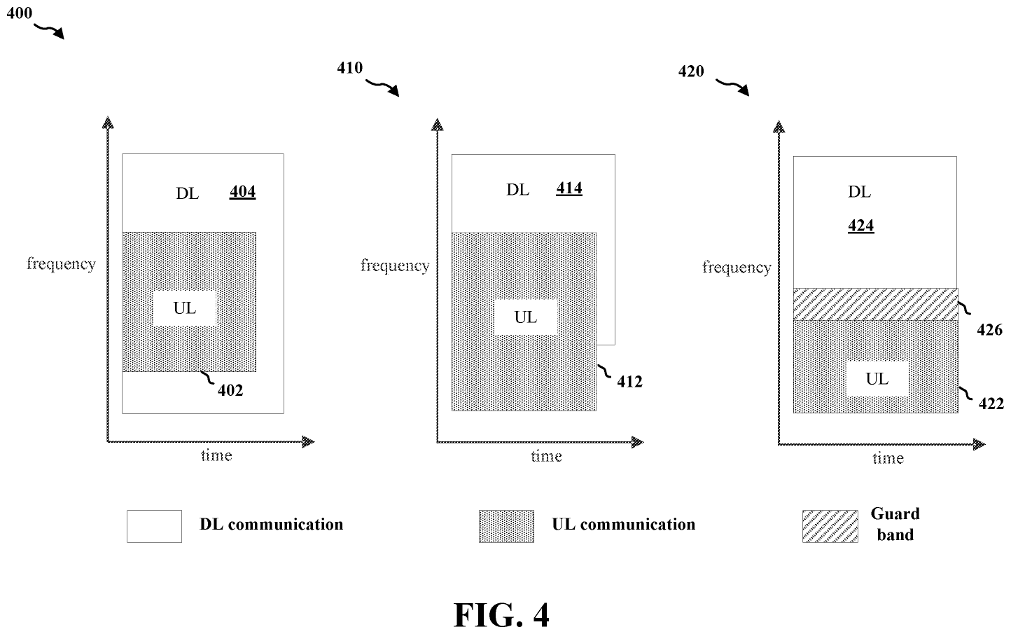

FIG. 4 illustrates a first example 400 and a second example 410 of in-band full-duplex (IBFD) resources and a third example 420 of sub-band full-duplex (SBFD) resources. In IBFD, signals may be transmitted and received in overlapping times and overlapping in frequency. As shown in the first example 400, a time and a frequency allocation of a UL resources 402 may fully overlap with a time and a frequency allocation of DL resources 404. In the second example 410, a time and a frequency allocation of UL resources 412 may partially overlap with a time and a frequency of allocation of DL resources 414.

IBFD is in contrast to sub-band frequency division duplex (FDD), where uplink and downlink resources may overlap in time using different frequencies, as shown in the third example 420. In the third example 420, the UL resources 422 are separated from the DL resources 424 by a guard band 426. The guard band may be frequency resources, or a gap in frequency resources, provided between the UL resources 422 and the DL resources 424. Separating the UL frequency resources and the DL frequency resources with a guard band may help to reduce self-interference (SI). UL resources and DL resources that are immediately adjacent to each other correspond to a guard band width of 0. As an output signal, e.g., from a UE transmitter, may extend outside the UL resources, the guard band may reduce interference experienced by the UE. Sub-band FDD may also be referred to as “flexible duplex.”

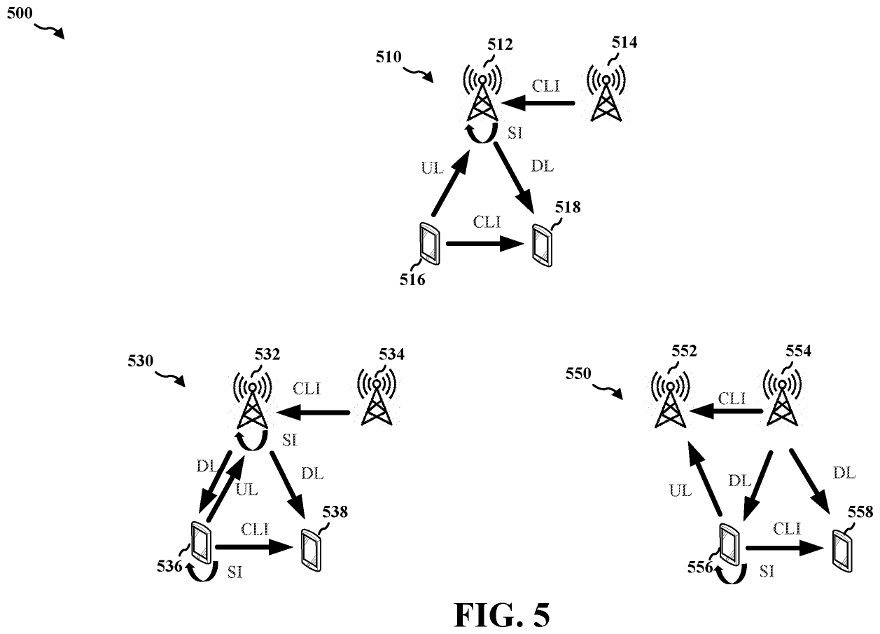

FIG. 5 is a diagram 500 illustrating various example deployment scenarios including one or more full-duplex devices. A full-duplex device (or a device working in a full-duplex mode) may transmit and receive at the same time. The diagram 510 illustrates an example deployment scenario including at least one full-duplex network node and two half-duplex UEs. Operating in the full-duplex mode, a first network node 512 may transmit to a second UE 518 and receive from a first UE 516 at the same time. The full-duplex operation may create SI at the first network node 512. In particular, at the first network node 512, the downlink transmission to the second UE 518 may cause interference to the uplink reception from the first UE 516. Further, the uplink transmission by the first UE 516 to the first network node 512 may cause cross-link interference (CLI) to the downlink reception by the second UE 518 from the first network node 512. Moreover, a transmission from a second network node 514 may cause CLI to the uplink reception at the first network node 512.

The diagram 530 illustrates an example deployment scenario including at least one full-duplex network node and at least one full-duplex UE/customer premises equipment (CPE). A first network node 532 may communicate with a first UE/CPE 536 in the full-duplex mode. In other words, uplink and downlink transmissions may take place at the same time between the first network node 532 and the first UE/CPE 536. At the same time, the first network node 532 may transmit to a second UE/CPE 538. The downlink transmissions to both the first UE/CPE 536 and the second UE/CPE 538 may cause SI to the uplink reception from the first UE/CPE 536 at the first network node 532. Further, the uplink transmission from the first UE/CPE 536 may cause SI to the downlink reception at the first UE/CPE 536, and may cause CLI to the downlink reception at the second UE/CPE 538. Moreover, a transmission from a second network node 534 may cause CLI to the uplink reception at the first network node 532.

The diagram 550 illustrates an example deployment scenario including two half-duplex network nodes (or two transmit receive points (TRPs)) and at least one full-duplex UE/CPE. A first UE/CPE 556 may work in the full-duplex mode. In particular, the first UE/CPE 556 may transmit to a first network node 552 and receive from a second network node 554 at the same time. Accordingly, the uplink transmission from the first UE/CPE 556 to the first network node 552 may cause SI to the downlink reception at the first UE/CPE 556. Further, the second network node 554 may transmit to a second UE/CPE 558 at the same time the second network node 554 transmits to the first UE/CPE 556. The downlink transmissions from the second network node 554 to both the first UE/CPE 556 and the second UE/CPE 558 may cause CLI to the uplink reception at the first network node 552. Further, the uplink transmission from the first UE/CPE 456 to the first network node 552 may cause CLI to the downlink reception at the second UE/CPE 558.

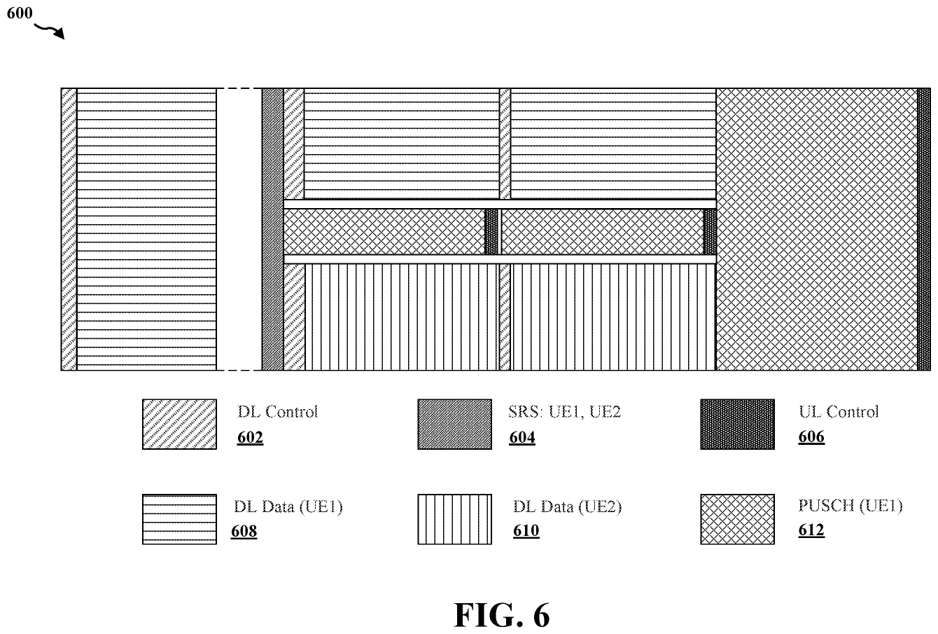

FIG. 6 is a diagram illustrating an example slot format of an example SBFD slot 600. The SBFD slot 600 may be a “DL+UL” (“D+U”) slot where the band may be used for both UL and DL transmissions. As shown, the SBFD slot 600 may accommodate one or more DL control channels 602, SRS resources 604 (e.g., for a first UE (UE1) and a second UE (UE2)), one or more UL control channels 606, one or more DL data channels 608 for UE1, one or more DL data channels 610 for UE2, and/or a PUSCH 612 for UE1. A “D+U” slot (e.g., the SBFD slot 600) may include DL symbols where UL transmissions are not permitted, UL symbols where DL transmissions are not permitted, or full-duplex (e.g., “D+U”) symbols. Further, the DL and UL transmissions may occur in overlapping bands (e.g., IBFD) or in adjacent bands (e.g., SBFD). In particular, in a given “D+U” symbol in the “D+U” slot, a half-duplex UE may cither transmit in the UL band or receive in the DL band, whereas a full-duplex UE may transmit in the UL band and/or receive in the DL band in the same slot.

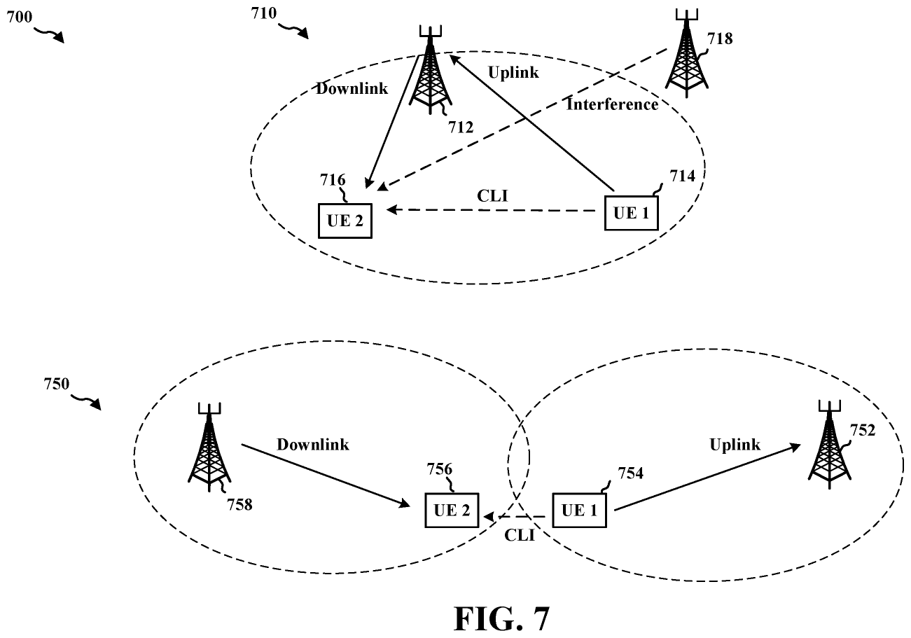

FIG. 7 is a diagram 700 illustrating examples scenarios where a UE may experience interference. In the scenario illustrated in the diagram 710, the first UE 714 and the second UE 716, which may be located in the same cell corresponding to the first network node 712, may operate in the half-duplex mode. Further, the first network node 712 may operate in the full-duplex mode (e.g., either IBFD or sub-band FDD). As illustrated in the diagram 710, the uplink transmission from the first UE 714 to the first network node 712 may cause intra-cell CLI to the downlink reception at the second UE 716 from the first network node 712. Further, the second UE 716 may also experience inter-cell interference from the second network node 718.

In the scenario illustrated in the diagram 750, the first UE 754 and the second UE 756, which may be located in different, adjacent cells corresponding to the first network node 752 and the second network node 758, respectively, may operate in the half-duplex mode. As illustrated in the diagram 750, the uplink transmission from the first UE 754 to the first network node 752 may cause inter-cell CLI to the downlink reception at the second UE 756 from the second network node 758.

Furthermore, as explained above, a UE operating in the full-duplex mode may experience SI.

In one or more configurations, the CSI report configuration (also referred to as the CSI reporting settings) may include one or more of a non-zero power (NZP) CSI-RS resource configuration for channel measurement, a CSI-RS resource for interference measurement (IM) (CSI-IM), an NZP CSI-RS configuration for IM, a codebook configuration, or a report type configuration (e.g., periodic reporting, semi-persistent reporting, aperiodic reporting, etc.). The NZP CSI-RS resource configuration for channel measurement may correspond to an NZP channel measurement resource (CMR) set in multiple NZP CMR sets. The NZP CMR set may include a number of NZP CMRs. Further, the CSI-IM may correspond to a CSI-IM resource set in multiple CSI-IM resource sets. The CSI-IM resource set may include a number of CSI-IM resources. Moreover, the NZP CSI-RS configuration for IM may correspond to an NZP IM resource (IMR) set in multiple NZP IMR sets. The NZP IMR set may include a number of NZP IMRs. There may be resource-wise association between the NZP CMRs and the CSI-IM resources. Further, each CSI-IM resource may be associated with all IMRs.

Moreover, the codebook configuration may specify a codebook type (e.g., Type I—single panel, Type I—multi-panel, Type II, etc.). The codebook type may be associated with an antenna configuration (e.g., (N1, N2) or (N_{g}, N1, N2) configuration and the DFT beam restriction, where N1 may be the number of columns of antenna elements in the panel, N2 may be the number of rows of antenna elements in the panel, and N_{g} may be the number of panels) and an RI restriction.

In one or more configurations, the CSI report configuration may be RRC configured for each BWP. Further, a resource set may have Ks resources (Ks being a positive integer), where each resource in the Ks resources may include a same number of CSI-RS ports. For example, for Ks=1, each resource may contain at most 32 CSI-RS ports. For Ks=2, each resource may contain at most 16 CSI-RS ports. Further, for 2<Ks<=8, each resource may contain at most 8 CSI-RS ports. In general, in some configurations, a P-port (P being a positive integer) resource may have ports labeled from 3000 to 300(P-1).

For the codebook configuration, different types for PMI codebook reporting may be available. For example, the PMI codebook reporting types may include Type I—single panel, Type I—multiple panels, Type II—single panel, Type II—port selection, or Type II—enhanced port selection. Further, for the antenna configuration, there may be specified supported configurations of the antenna elements configuration (N1, N2) and the number of panels (N_{g}) for each codebook type and a corresponding number of CSI-RS antenna ports (per resource) (which may be equal to 2*N_{g}*N1*N2). For example, Table 5.2.2.2.1-2 of the technical specification (TS) 38.214 may specify supported configurations of (N1, N2) and (O1, O2) and Table 5.2.2.2.2-1 of TS 38.214 may specify supported configurations of (N_{g}, N1, N2) and (O1, O2).

In one or more configurations, the CSI reporting may be one of two types. In particular, Type I CSI reporting may be single-slot reporting. A CSI report may include up to 2 parts: Part 1 may include the RI/CSI-RS resource indicator (CRI) and the CQI for the first codeword and Part 2 may include the PMI and the CQI for the second codeword (e.g., when the RI is greater than 4). Periodic/semi-persistent/aperiodic reporting may be supported for the Type I CSI reporting. A Type I CSI report may be carried via the PUCCH and/or the PUSCH (the PUCCH and/or the PUSCH may be short or long). Further, Type I sub-band CSI reports may be carried via the PUSCH and/or the long PUCCH.

Moreover, Type II CSI reporting may also include up to 2 parts: Part 1 may include RI, CQI, and an indication of the number of non-zero wideband amplitude coefficients for each layer and Part 2 may include the PMI corresponding to indicated non-zero wideband amplitude coefficients for each layer as reported in Part 1. Part 1 may be associated with a fixed payload size and each field in Part 1 may be encoded separately. Accordingly, Part 1 may be used to identify the number of information bits in Part 2. Semi-persistent/aperiodic reporting may be supported for the Type II CSI reporting. A Type II CSI report may be carried via the long PUCCH (Part 1 but not Part 2) and/or the PUSCH (Part 1 and Part 2).

In some configurations, CSI parameters of a report may not be multiplexed across PUCCH or PUSCH transmissions. Further, CSI reports on the long PUCCH and on the PUSCH may be calculated independently. Whether a UE may be configured with Type II CSI reports on both the long PUCCH and the PUSCH may be dependent upon the UE capability. Moreover, The layer 1-reference signal received power (L1-RSRP) and the resource indicators for beam management may be mapped to Part 1 when the Type II CSI report is carried via the long PUCCH or the PUSCH.

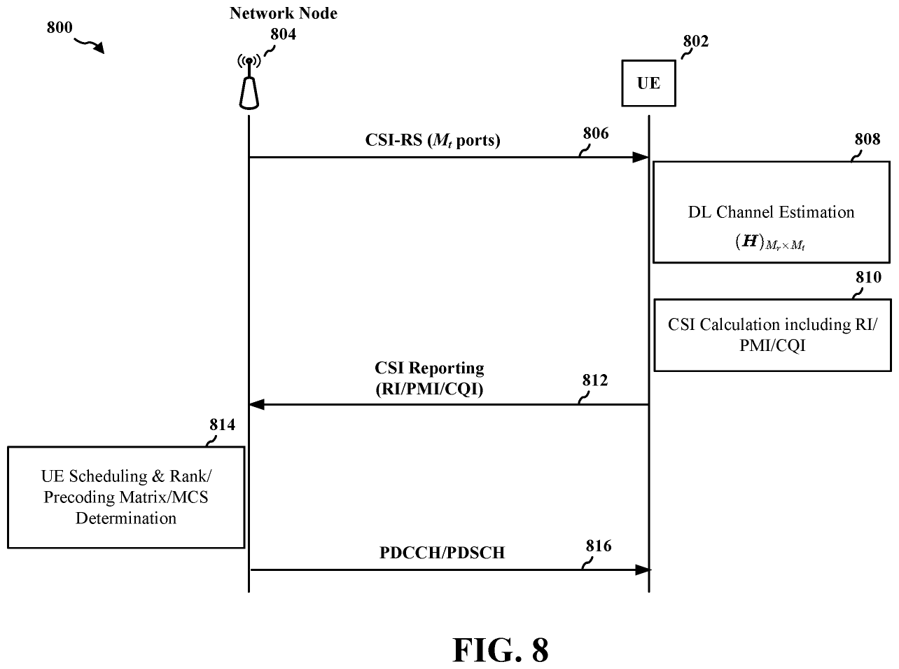

FIG. 8 is a diagram of a communication flow 800 of a method of link adaptation. At 806, the network node 804 may transmit a CSI-RS (which may be an Mₜ-port CSI-RS) (Mₜ being a positive integer) for the UE 802. At 808, the UE 802 may perform DL channel estimation based on the CSI-RS. At 810, the UE 802 may calculate the CSI parameters including the RI, the PMI, and/or the CQI. In particular, for an Mᵣ×Mₜ downlink channel matrix (H) and the codebook from rank-1 to rank-R: {{P₁(0), . . . , P₁(L₁−1)}, . . . , {P_{R}(O), . . . , P_{R}(L_{R}−1)}} (Mᵣ may be the number of receive antennas (or antenna elements) and Mₜ may be the number of transmit antennas (or antenna elements)), the UE 802 may select the precoder (associated with a PMI index i*) and the rank (R*) for a given codebook: (R*, i*)=argmax_{r,i} SEₑₛₜ(H, Pᵣ(i)), where SEₑₛₜ (H, Pᵣ(i)) may refer to spectral efficiency estimation that may be performed by the UE 802 when H and Pᵣ(i) are given. Accordingly, the optimal rank may be R* and the optimal precoder may be P_{R*}(i*). The CQI calculation at the UE 802 may be conditioned on the optimal rank and precoder: CQI*=f (SEₑₛₜ(H, P_{R*}(i*)).

At 812, the UE 802 may transmit, for the network node 804, the CSI report. The CSI report may include the RI, the PMI, and/or the CQI. At 814, the network node 804 may perform UE scheduling, and may determine the rank, the precoding matrix, and/or the modulation and coding scheme (MCS) based on the CSI report. At 816, the network node 804 may transmit, for the UE802, a PDCCH/PDSCH based on the UE scheduling and the determined rank, precoding matrix, and/or MCS.

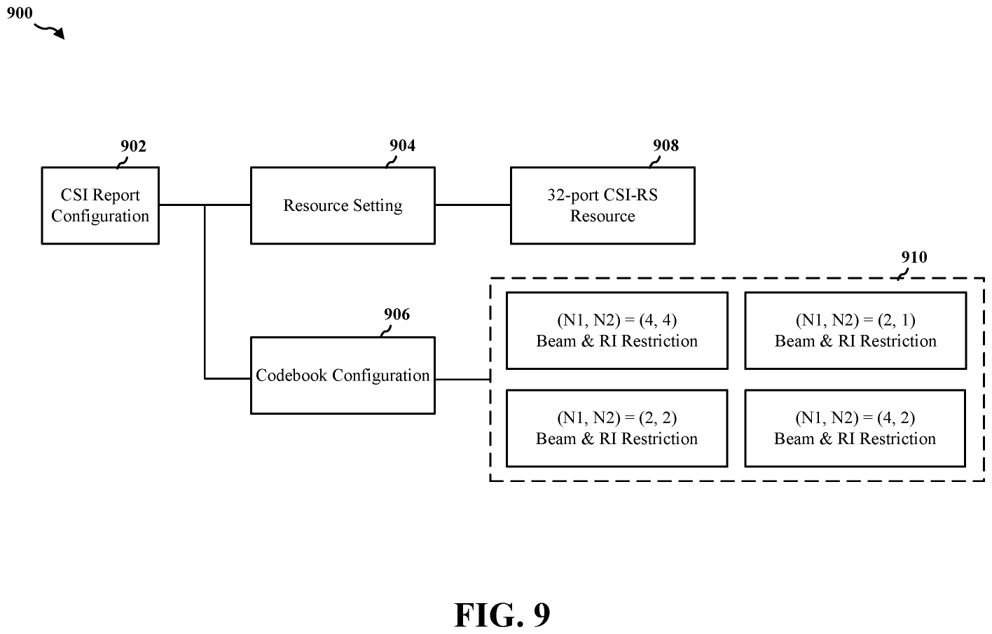

FIG. 9 is a diagram illustrating an example CSI framework 900 for dynamic antenna port adaptation. As shown, the CSI report configuration may include a resource setting 904 and a codebook configuration 906. The resource setting 904 may correspond to a (e.g., 32-port) CSI-RS resource 908. Further, the codebook configuration 906 may include beam and RI restrictions 910 for different antenna port configurations (e.g., (N1, N2) configurations).

Accordingly, the UE may be configured with multiple codebooks in a CSI report configuration 902. Each codebook may be associated with an antenna port configuration (e.g., an (N1, N2) configuration), which may include a beam restriction and an RI restriction. The resource for CSI measurement may be shared among configured codebooks. Further, the UE may transmit the CSI report to the network node. The CSI report may include CSI parameters associated with a subset of the codebooks. As such, the UE may compute CSI parameters for each codebook, and may sort the CSI parameters (e.g., based on spectral efficiency). Then, the UE may report one or a subset of the best CSI parameters in the same CSI report.

In some configurations, a sub-band CQI may be a differential CQI (e.g., with a length of 2 bits) with respect to the wideband CQI. For example, Table 5.2.2.1-1 may specify a mapping from sub-band differential CQI values to offset values, where the offset values may indicate index offsets between the sub-band CQI indexes and the wideband CQI index. In some other configurations, a sub-band CQI may be a sub-band absolute CQI (e.g., with a length of 4 bits).

If the channel does not experience significant frequency selectivity, the sub-band CQI offset from the wideband CQI may be zero or close to zero for most of the sub-bands. Both differential sub-band CQI reporting and absolute sub-band CQI reporting may be associated with reporting overhead (e.g., 2 bits for the differential reporting and 4 bits for the absolute reporting). However, if the channel has low frequency selectivity (i.e., the channel condition does not vary significantly across the spectrum), the bits used for the sub-band CQI reporting may be redundant.

Accordingly, in some aspects, the UE may implicitly report that the channel has low frequency selectivity. Then, the UE may refrain from explicitly reporting the sub-band CQI and/or PMI when transmitting the CSI report. Accordingly, the bits associated with the sub-band CQI and/or PMI reporting may be saved, leading to more efficient CSI-RS report compression.

On the other hand, in full-duplex networks, the channel quality may have certain characteristics. For example, on average, the channel may become better as the separation between the DL and UL sub-bands increases. Therefore, frequency selectivity may be reported on a per sub-band basis.

Accordingly, in some aspects, the UE may implicitly indicate to a network node low frequency selectivity of the channel. Accordingly, CSI overhead may be reduced. Further, less sub-band CQI and/or PMI processing at the UE may be performed, which may lead to less power consumption at the UE.

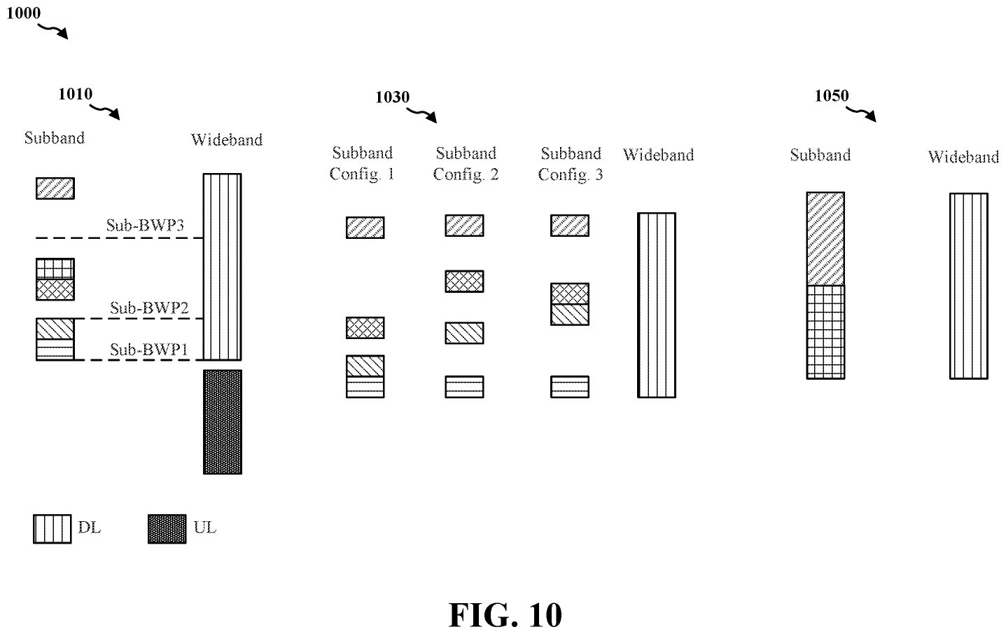

FIG. 10 is a diagram 1000 illustrating example sub-band CQI reporting according to one or more aspects.

In one configuration, the UE may be configured with a set of sub-band sizes and a number of sub-bands for each sub-BWP/sub-band, such that the UE may select the sub-bands for which the UE may explicitly report the CQI and/or the PMI. In some configurations, the UE may be limited to certain combinations of sub-bands for which the CQI and/or the PMI may be explicitly reported. The sub-bands in each combination may be within a respective sub-BWP. The UE may indicate to the network node the combination selected by the UE prior to transmitting the CSI report including the CQI and/or the PMI. For example, if there are 4 options corresponding to 4 possible combinations of sub-bands, the UE may transmit a 2-bit indication to the network node to indicate the selected option. In some configurations, the reporting may be performed via a 2-stage UCI message. In particular, the UE may indicate, via the first stage UCI message, the selected combination of sub-bands for which the CQI and/or the PMI are to be (explicitly) reported. Then, the UE may report, via the second stage UCI message, the sub-band CQI and/or PMI for the sub-bands in the selected combination.

As shown in the diagram 1010, a UE-selected combination of sub-bands may include 5 sub-bands not covering the whole wideband. The 5 sub-bands may include 2 sub-bands in the first sub-BWP (sub-BWP1), 2 sub-bands in the second sub-BWP (sub-BWP2), and 1 sub-band in the third sub-BWP (sub-BWP3). The UE may report explicitly the CQI and/or PMI for the 5 sub-bands but not for other sub-bands in the CSI report.

In some configurations, the combination of sub-bands selected by the UE may serve as an indication of the preferred RBs (for transmission and/or reception) from the UE's perspective. For example, the 5 sub-bands shown in the diagram 1010 may correspond to the RBs preferred by the UE. Based on this understanding, the network node may use these RBs for transmissions to the UE.

In some configurations, a table may be defined (e.g., prespecified or based on RRC configuration) to provide the possible sub-band sizes and the number of sub-bands for each bandwidth. Table 2 below may be one such example table.

TABLE 2
Sub-band sizes and the number of sub-
bands for different bandwidths

| Reporting Bandwidth | Sub-band Size | Number of |
|---|---|---|
| in RBs | (in RBs) | Sub-bands |
| 8 < Bandwidth < 10 | 2 | 4 |
| 10 <= Bandwidth < 40 | 2 | 6 |
| 40 <= Bandwidth < 80 | 4 | 8 |
| 80 <= Bandwidth < 100 | 8 | 10 |

In addition to the table, the UE may be (pre)configured with multiple possible sub-band configurations. The diagram 1030 may illustrate 3 example preconfigured sub-band configurations, where 4 sub-bands may be specified according to each of the configurations. The UE may explicitly report the CQI and/or the PMI for the 4 sub-bands associated with a UE-selected sub-band configuration. Accordingly, the UE may indicate to the network node the sub-band configuration selected by the UE prior to transmitting the CSI report including the CQI and/or the PMI.

In some configurations, a UE that is configured to report the sub-band CQI/PMI with a certain sub-band size may drop or combine sub-bands in the CSI report depending on the variability of the CQI/PMI across the sub-bands. Accordingly, in addition to reporting the CQI/PMI value in the CSI report, the UE may also report the sub-band sizes. In some configurations, the 2-stage UCI message may be used for the reporting. For example, the UE may indicate, via the first stage UCI message, the sizes (and possibly locations) of sub-bands for which the CQI and/or the PMI are to be explicitly reported. Then, the UE may report, via the second stage UCI message, the sub-band CQI and/or PMI for the sub-bands.

For example, if all sub-bands have the same CQI as the wideband, it may be sufficient to report the CQI/PMI for one sub-band having the same size (bandwidth) as the entire wideband. In another example, as shown in the diagram 1050, the UE may split the wideband into two sub-bands, where the first sub-band may have the same CQI/PMI as the wideband and the second sub-band may have a different CQI/PMI.

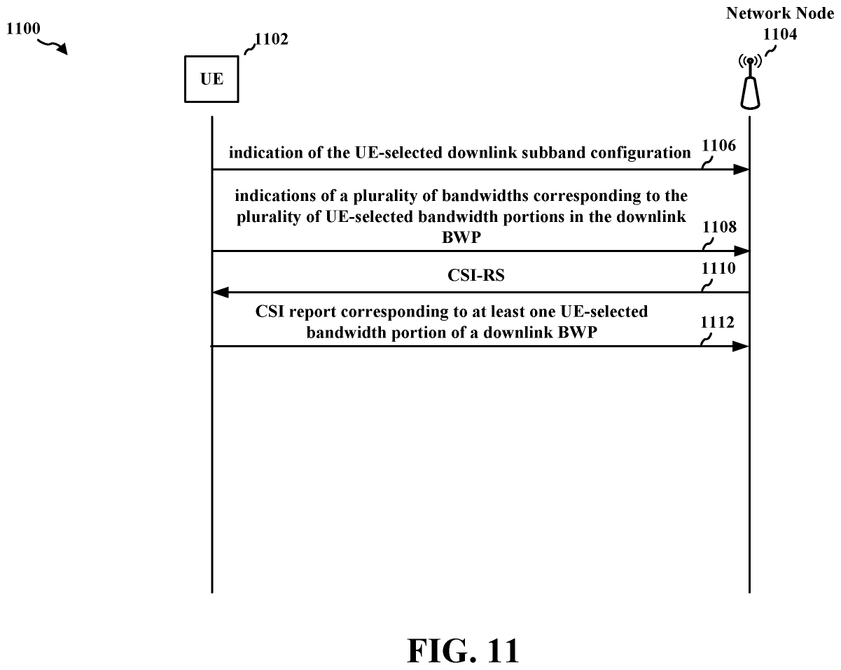

FIG. 11 is a diagram of a communication flow 1100 of a method of wireless communication. The UE 1102 may implement aspects of the UE 104/350. Further, the network node 1104 may implement aspects of the base station 102/310. In some configurations, at 1106, the UE 1102 may transmit, prior to transmitting the CSI report at 1112, an indication of the UE-selected downlink sub-band configuration to the network node 1104.

In some configurations, at 1108, the UE 1102 may transmit indications of a plurality of bandwidths corresponding to the plurality of UE-selected bandwidth portions (e.g., sub-bands) in the downlink BWP to the network node 1104.

At 1110, the network node 1104 may transmit a CSI-RS to the UE 1102.

At 1112, the UE 1102 may transmit a CSI report corresponding to at least one UE-selected bandwidth portion of the downlink BWP to the network node 1104 based on the CSI-RS.

In one configuration, the CSI report at 1112 may include at least one CQI for the at least one UE-selected bandwidth portion of the downlink BWP.

In one configuration, the at least one UE-selected bandwidth portion of the downlink BWP may correspond to at least one downlink sub-band associated with the UE-selected downlink sub-band configuration in a plurality of usable downlink sub-band configurations.

In one configuration, the at least one UE-selected bandwidth portion of the downlink BWP may include a plurality of downlink sub-bands associated with the UE-selected downlink sub-band configuration.

In one configuration, each usable downlink sub-band configuration in the plurality of usable downlink sub-band configurations may be associated with a specified number of sub-bands of a specified sub-band size.

In one configuration, the plurality of usable downlink sub-band configurations may be preconfigured.

In one configuration, the plurality of usable downlink sub-band configurations may be configured at the UE 1102 based on RRC signaling from the network node 1104.

In one configuration, the at least one UE-selected bandwidth portion of the downlink BWP may include a single UE-selected bandwidth portion corresponding to the entire downlink BWP.

In one configuration, the at least one UE-selected bandwidth portion of the downlink BWP may include a plurality of UE-selected bandwidth portions in the downlink BWP. The CSI report at 1112 may include a respective CQI for each UE-selected bandwidth portion in the plurality of UE-selected bandwidth portions.

In one configuration, the downlink BWP may be associated with a full-duplex operation.

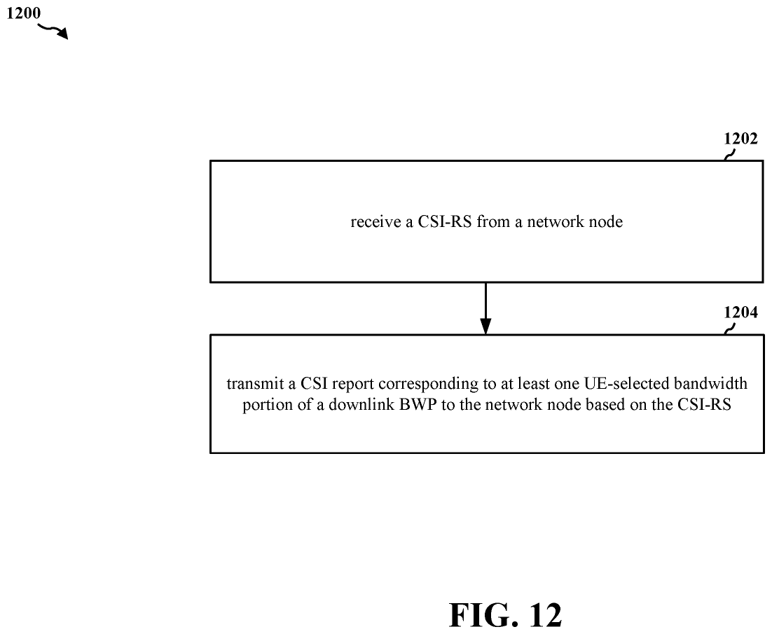

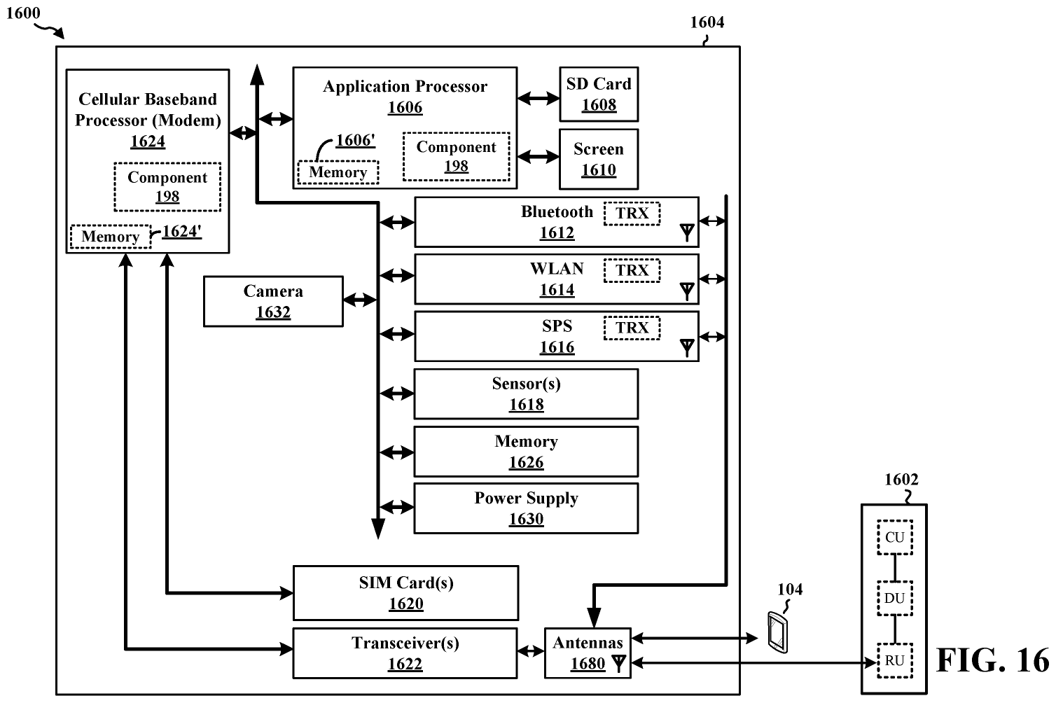

FIG. 12 is a flowchart 1200 of a method of wireless communication. The method may be performed by a UE (e.g., the UE 104/350/1102; the apparatus 1604). At 1202, the UE may receive a CSI-RS from a network node. For example, 1202 may be performed by the component 198 in FIG. 16. Referring to FIG. 11, at 1110, the UE 1102 may receive a CSI-RS from a network node 1104.

At 1204, the UE may transmit a CSI report corresponding to at least one UE-selected bandwidth portion of a downlink BWP to the network node based on the CSI-RS. For example, 1204 may be performed by the component 198 in FIG. 16. Referring to FIG. 11, at 1112, the UE 1102 may transmit a CSI report corresponding to at least one UE-selected bandwidth portion of a downlink BWP to the network node 1104 based on the CSI-RS.

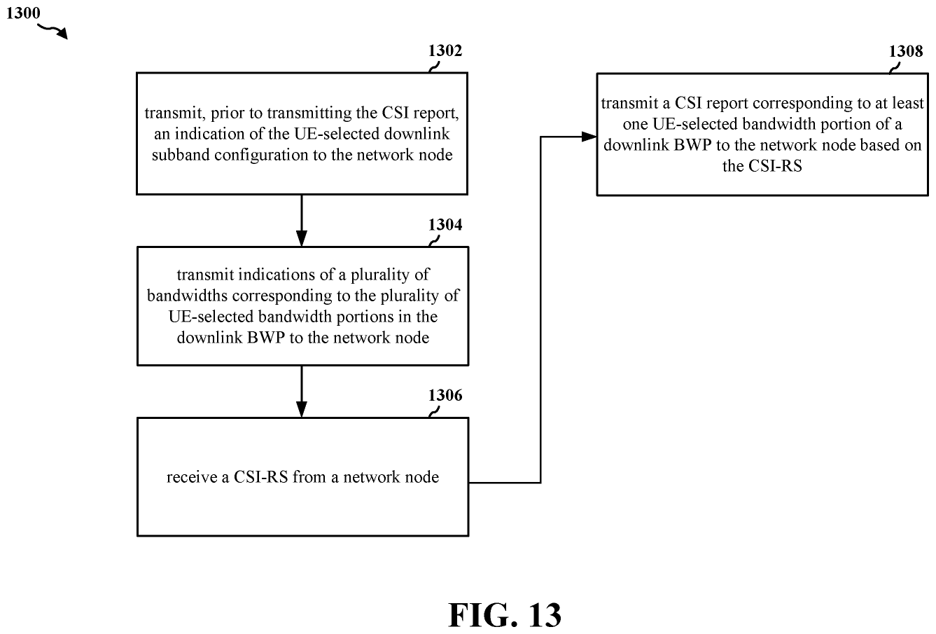

FIG. 13 is a flowchart 1300 of a method of wireless communication. The method may be performed by a UE (e.g., the UE 104/350/1102; the apparatus 1604). At 1306, the UE may receive a CSI-RS from a network node. For example, 1306 may be performed by the component 198 in FIG. 16. Referring to FIG. 11, at 1110, the UE 1102 may receive a CSI-RS from a network node 1104.

At 1308, the UE may transmit a CSI report corresponding to at least one UE-selected bandwidth portion of a downlink BWP to the network node based on the CSI-RS. For example, 1308 may be performed by the component 198 in FIG. 16. Referring to FIG. 11, at 1112, the UE 1102 may transmit a CSI report corresponding to at least one UE-selected bandwidth portion of a downlink BWP to the network node 1104 based on the CSI-RS.

In one configuration, referring to FIG. 11, the CSI report at 1112 may include at least one CQI for the at least one UE-selected bandwidth portion of the downlink BWP.

In one configuration, the at least one UE-selected bandwidth portion of the downlink BWP may correspond to at least one downlink sub-band associated with a UE-selected downlink sub-band configuration in a plurality of usable downlink sub-band configurations.

In one configuration, the at least one UE-selected bandwidth portion of the downlink BWP may include a plurality of downlink sub-bands associated with the UE-selected downlink sub-band configuration.

In one configuration, at 1302, the UE may transmit, prior to transmitting the CSI report, an indication of the UE-selected downlink sub-band configuration to the network node. For example, 1302 may be performed by the component 198 in FIG. 16. Referring to FIG. 11, at 1112, the UE 1102 may transmit, prior to transmitting the CSI report at 1112, an indication of the UE-selected downlink sub-band configuration to the network node 1104.

In one configuration, the plurality of usable downlink sub-band configurations may be preconfigured.

In one configuration, referring to FIG. 11, the plurality of usable downlink sub-band configurations may be configured based on RRC signaling from the network node 1104.

In one configuration, each usable downlink sub-band configuration in the plurality of usable downlink sub-band configurations may be associated with a specified number of sub-bands of a specified sub-band size.

In one configuration, the at least one UE-selected bandwidth portion of the downlink BWP may include a single UE-selected bandwidth portion corresponding to the entire downlink BWP.

In one configuration, the at least one UE-selected bandwidth portion of the downlink BWP may include a plurality of UE-selected bandwidth portions in the downlink BWP. Referring to FIG. 11, the CSI report at 1112 may include a respective CQI for each UE-selected bandwidth portion in the plurality of UE-selected bandwidth portions.

In one configuration, at 1304, the UE may transmit indications of a plurality of bandwidths corresponding to the plurality of UE-selected bandwidth portions in the downlink BWP to the network node. For example, 1304 may be performed by the component 198 in FIG. 16. Referring to FIG. 11, at 1108, the UE 1102 may transmit indications of a plurality of bandwidths corresponding to the plurality of UE-selected bandwidth portions in the downlink BWP to the network node 1104.

In one configuration, the downlink BWP may be associated with a full-duplex operation.

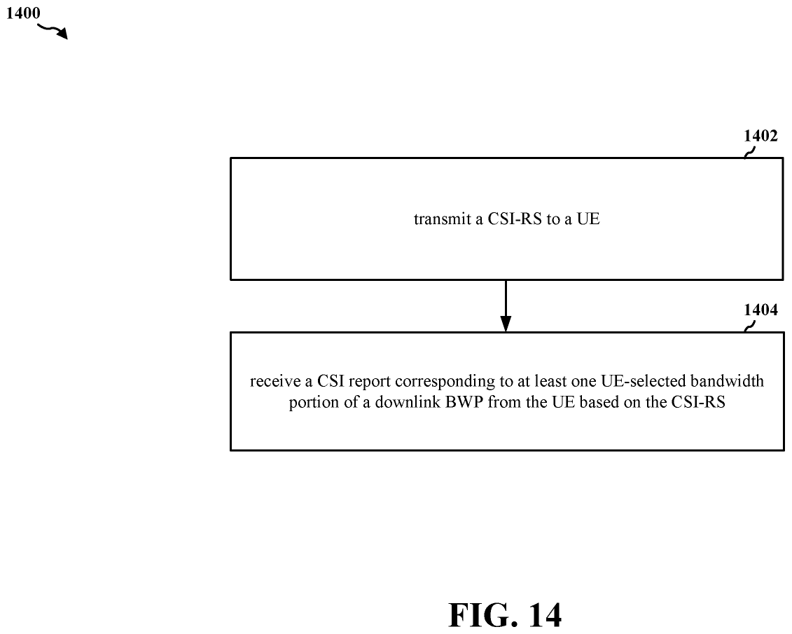

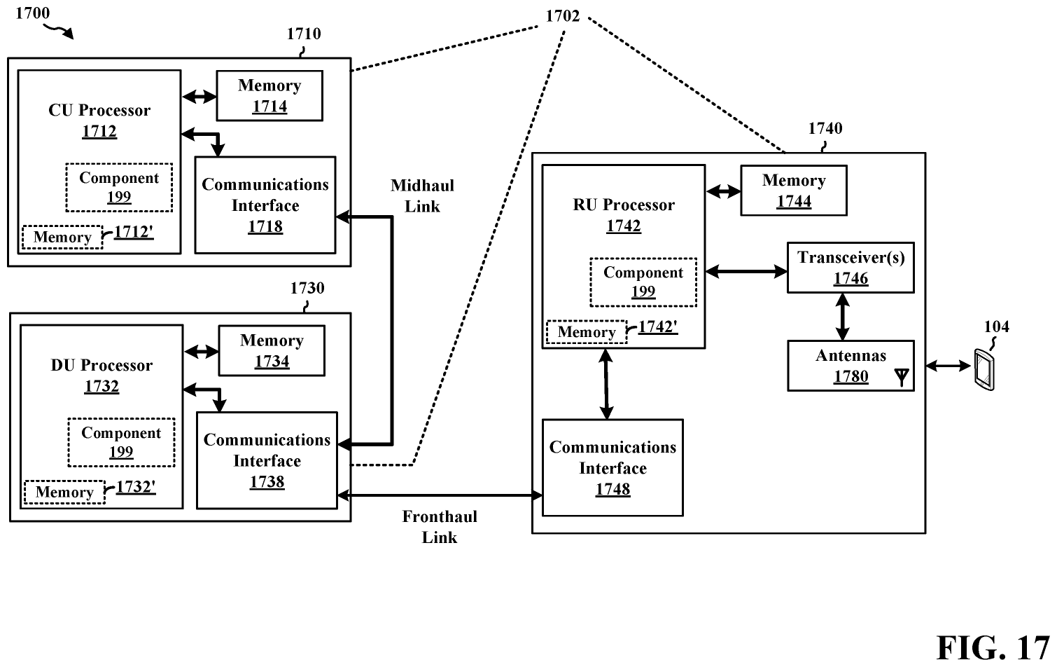

FIG. 14 is a flowchart 1400 of a method of wireless communication. The method may be performed by a network node (e.g., the base station 102/310; the network node 1104; the network entity 1602). At 1402, the network node may transmit a CSI-RS to a UE. For example, 1402 may be performed by the component 199 in FIG. 17. Referring to FIG. 11, at 1110, the network node 1104 may transmit a CSI-RS to a UE 1102.

At 1404, the network node may receive a CSI report corresponding to at least one UE-selected bandwidth portion of a downlink BWP from the UE based on the CSI-RS. For example, 1404 may be performed by the component 199 in FIG. 17. Referring to FIG. 11, at 1112, the network node 1104 may receive a CSI report corresponding to at least one UE-selected bandwidth portion of a downlink BWP from the UE 1102 based on the CSI-RS.

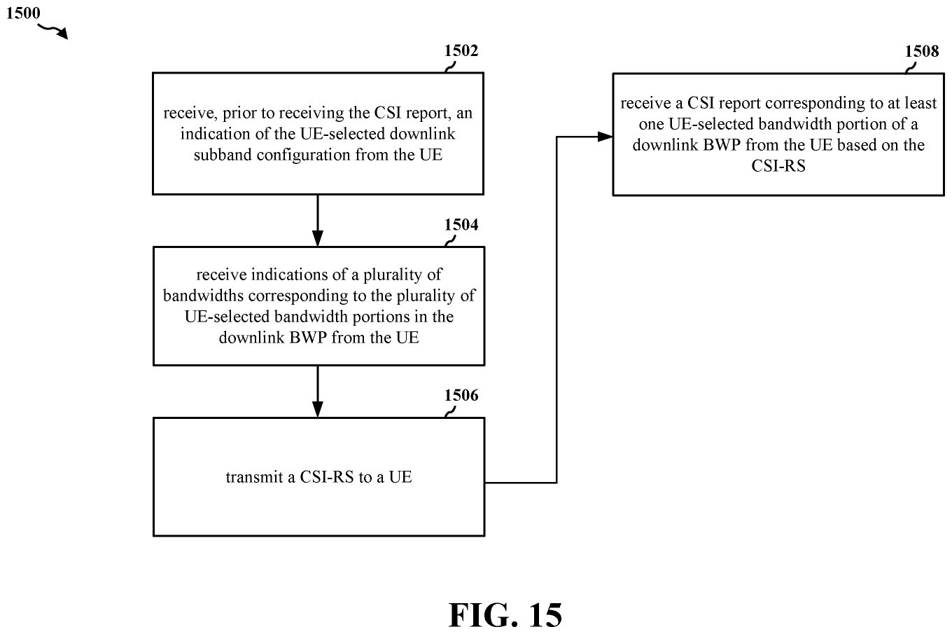

FIG. 15 is a flowchart 1500 of a method of wireless communication. The method may be performed by a network node (e.g., the base station 102/310; the network node 1104; the network entity 1602). At 1506, the network node may transmit a CSI-RS to a UE. For example, 1506 may be performed by the component 199 in FIG. 17. Referring to FIG. 11, at 1110, the network node 1104 may transmit a CSI-RS to a UE 1102.

At 1508, the network node may receive a CSI report corresponding to at least one UE-selected bandwidth portion of a downlink BWP from the UE based on the CSI-RS. For example, 1508 may be performed by the component 199 in FIG. 17. Referring to FIG. 11, at 1112, the network node 1104 may receive a CSI report corresponding to at least one UE-selected bandwidth portion of a downlink BWP from the UE 1102 based on the CSI-RS.

In one configuration, referring to FIG. 11, the CSI report at 1112 may include at least one CQI for the at least one UE-selected bandwidth portion of the downlink BWP.

In one configuration, the at least one UE-selected bandwidth portion of the downlink BWP may correspond to at least one downlink sub-band associated with a UE-selected downlink sub-band configuration in a plurality of usable downlink sub-band configurations.

In one configuration, the at least one UE-selected bandwidth portion of the downlink BWP may include a plurality of downlink sub-bands associated with the UE-selected downlink sub-band configuration.

In one configuration, at 1502, the network node may receive, prior to receiving the CSI report, an indication of the UE-selected downlink sub-band configuration from the UE. For example, 1502 may be performed by the component 199 in FIG. 17. Referring to FIG. 11, at 1106, the network node 1104 may receive, prior to receiving the CSI report at 1112, an indication of the UE-selected downlink sub-band configuration from the UE 1102.

In one configuration, the plurality of usable downlink sub-band configurations may be preconfigured.

In one configuration, referring to FIG. 11, the plurality of usable downlink sub-band configurations may be configured based on RRC signaling from the network node 1104.

In one configuration, each usable downlink sub-band configuration in the plurality of usable downlink sub-band configurations may be associated with a specified number of sub-bands of a specified sub-band size.

In one configuration, the at least one UE-selected bandwidth portion of the downlink BWP may include a single UE-selected bandwidth portion corresponding to the entire downlink BWP.

In one configuration, the at least one UE-selected bandwidth portion of the downlink BWP may include a plurality of UE-selected bandwidth portions in the downlink BWP. Referring to FIG. 11, the CSI report at 1112 may include a respective CQI for each UE-selected bandwidth portion in the plurality of UE-selected bandwidth portions.

In one configuration, at 1504, the network node may receive indications of a plurality of bandwidths corresponding to the plurality of UE-selected bandwidth portions in the downlink BWP from the UE. For example, 1504 may be performed by the component 199 in FIG. 17. Referring to FIG. 11, at 1108, the network node 1104 may receive indications of a plurality of bandwidths corresponding to the plurality of UE-selected bandwidth portions in the downlink BWP from the UE 1102.

In one configuration, the downlink BWP may be associated with a full-duplex operation.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., sec 350 of FIG. 3) and include the additional modules of the apparatus 1604.

As discussed supra, the component 198 is configured to receive a CSI-RS from a network node. The component 198 is configured to transmit a CSI report corresponding to at least one UE-selected bandwidth portion of a downlink BWP to the network node based on the CSI-RS. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving a CSI-RS from a network node. The apparatus 1604, and in particular the cellular baseband processor 1624 and/or the application processor 1606, includes means for transmitting a CSI report corresponding to at least one UE-selected bandwidth portion of a downlink BWP to the network node based on the CSI-RS.

In one configuration, the CSI report may include at least one CQI for the at least one UE-selected bandwidth portion of the downlink BWP. In one configuration, the at least one UE-selected bandwidth portion of the downlink BWP may correspond to at least one downlink sub-band associated with a UE-selected downlink sub-band configuration in a plurality of usable downlink sub-band configurations. In one configuration, the at least one UE-selected bandwidth portion of the downlink BWP may include a plurality of downlink sub-bands associated with the UE-selected downlink sub-band configuration. In one configuration, the apparatus 1604, and in particular the cellular baseband processor 1624 and/or the application processor 1606, includes means for transmitting, prior to transmitting the CSI report, an indication of the UE-selected downlink sub-band configuration to the network node. In one configuration, the plurality of usable downlink sub-band configurations may be preconfigured. In one configuration, the plurality of usable downlink sub-band configurations may be configured based on RRC signaling from the network node. In one configuration, each usable downlink sub-band configuration in the plurality of usable downlink sub-band configurations may be associated with a specified number of sub-bands of a specified sub-band size. In one configuration, the at least one UE-selected bandwidth portion of the downlink BWP may include a single UE-selected bandwidth portion corresponding to the entire downlink BWP. In one configuration, the at least one UE-selected bandwidth portion of the downlink BWP may include a plurality of UE-selected bandwidth portions in the downlink BWP. The CSI report may include a respective CQI for each UE-selected bandwidth portion in the plurality of UE-selected bandwidth portions. In one configuration, the apparatus 1604, and in particular the cellular baseband processor 1624 and/or the application processor 1606, includes means for transmitting indications of a plurality of bandwidths corresponding to the plurality of UE-selected bandwidth portions in the downlink BWP to the network node. In one configuration, the downlink BWP may be associated with a full-duplex operation.

The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′. 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit a CSI-RS to a UE. The component 199 is configured to receive a CSI report corresponding to at least one UE-selected bandwidth portion of a downlink BWP from the UE based on the CSI-RS. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for transmitting a CSI-RS to a UE. The network entity 1702 includes means for receiving a CSI report corresponding to at least one UE-selected bandwidth portion of a downlink BWP from the UE based on the CSI-RS.

In one configuration, the CSI report may include at least one CQI for the at least one UE-selected bandwidth portion of the downlink BWP. In one configuration, the at least one UE-selected bandwidth portion of the downlink BWP may correspond to at least one downlink sub-band associated with a UE-selected downlink sub-band configuration in a plurality of usable downlink sub-band configurations. In one configuration, the at least one UE-selected bandwidth portion of the downlink BWP may include a plurality of downlink sub-bands associated with the UE-selected downlink sub-band configuration. In one configuration, the network entity 1702 includes means for receiving, prior to receiving the CSI report, an indication of the UE-selected downlink sub-band configuration from the UE. In one configuration, the plurality of usable downlink sub-band configurations may be preconfigured. In one configuration, the plurality of usable downlink sub-band configurations may be configured based on RRC signaling from the network node. In one configuration, each usable downlink sub-band configuration in the plurality of usable downlink sub-band configurations may be associated with a specified number of sub-bands of a specified sub-band size. In one configuration, the at least one UE-selected bandwidth portion of the downlink BWP may include a single UE-selected bandwidth portion corresponding to the entire downlink BWP. In one configuration, the at least one UE-selected bandwidth portion of the downlink BWP may include a plurality of UE-selected bandwidth portions in the downlink BWP. The CSI report may include a respective CQI for each UE-selected bandwidth portion in the plurality of UE-selected bandwidth portions. In one configuration, the network entity 1702 includes means for receiving indications of a plurality of bandwidths corresponding to the plurality of UE-selected bandwidth portions in the downlink BWP from the UE. In one configuration, the downlink BWP may be associated with a full-duplex operation.

The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

Referring back to FIGS. 4-17, a network node may transmit a CSI-RS to a UE. The UE may transmit a CSI report corresponding to at least one UE-selected bandwidth portion of a downlink BWP to the network node based on the CSI-RS. Accordingly, CSI overhead may be reduced. Further, less sub-band CQI and/or PMI processing at the UE may be performed, which may lead to lower power consumption at the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a CSI-RS from a network node; and transmitting a CSI report corresponding to at least one UE-selected bandwidth portion of a downlink BWP to the network node based on the CSI-RS.

Aspect 2 is the method of aspect 1, where the CSI report includes CQI for the at least one UE-selected bandwidth portion of the downlink BWP.

Aspect 3 is the method of any of aspects 1 and 2, where the at least one UE-selected bandwidth portion of the downlink BWP corresponds to at least one downlink sub-band associated with a UE-selected downlink sub-band configuration in a plurality of usable downlink sub-band configurations.

Aspect 4 is the method of aspect 3, where the at least one UE-selected bandwidth portion of the downlink BWP includes a plurality of downlink sub-bands associated with the UE-selected downlink sub-band configuration.

Aspect 5 is the method of any of aspects 3 and 4, further including: transmitting, prior to transmitting the CSI report, an indication of the UE-selected downlink sub-band configuration to the network node.

Aspect 6 is the method of any of aspects 3 to 5, where the plurality of usable downlink sub-band configurations is preconfigured.

Aspect 7 is the method of any of aspects 3 to 5, where the plurality of usable downlink sub-band configurations is configured based on RRC signaling from the network node.

Aspect 8 is the method of any of aspects 3 to 7, where each usable downlink sub-band configuration in the plurality of usable downlink sub-band configurations is associated with a specified number of sub-bands of a specified sub-band size.

Aspect 9 is the method of any of aspects 1 and 2, where the at least one UE-selected bandwidth portion of the downlink BWP includes a single UE-selected bandwidth portion corresponding to the entire downlink BWP.

Aspect 10 is the method of any of aspects 1 and 2, where the at least one UE-selected bandwidth portion of the downlink BWP includes a plurality of UE-selected bandwidth portions in the downlink BWP, and the CSI report includes a respective CQI for each UE-selected bandwidth portion in the plurality of UE-selected bandwidth portions.

Aspect 11 is the method of aspect 10, further including: transmitting indications of a plurality of bandwidths corresponding to the plurality of UE-selected bandwidth portions in the downlink BWP to the network node.

Aspect 12 is the method of any of aspects 1 to 11, where the downlink BWP is associated with a full-duplex operation.

Aspect 13 is a method of wireless communication at a network node, including transmitting a CSI-RS to a UE; and receiving a CSI report corresponding to at least one UE-selected bandwidth portion of a downlink BWP from the UE based on the CSI-RS.

Aspect 14 is the method of aspect 13, where the CSI report includes CQI for the at least one UE-selected bandwidth portion of the downlink BWP.

Aspect 15 is the method of any of aspects 13 and 14, where the at least one UE-selected bandwidth portion of the downlink BWP corresponds to at least one downlink sub-band associated with a UE-selected downlink sub-band configuration in a plurality of usable downlink sub-band configurations.

Aspect 16 is the method of aspect 15, where the at least one UE-selected bandwidth portion of the downlink BWP includes a plurality of downlink sub-bands associated with the UE-selected downlink sub-band configuration.

Aspect 17 is the method of any of aspects 15 and 16, further including: receiving, prior to receiving the CSI report, an indication of the UE-selected downlink sub-band configuration from the UE.

Aspect 18 is the method of any of aspects 15 to 17, where the plurality of usable downlink sub-band configurations is preconfigured.

Aspect 19 is the method of any of aspects 15 to 17, where the plurality of usable downlink sub-band configurations is configured based on RRC signaling from the network node.

Aspect 20 is the method of any of aspects 15 to 19, where each usable downlink sub-band configuration in the plurality of usable downlink sub-band configurations is associated with a specified number of sub-bands of a specified sub-band size.

Aspect 21 is the method of any of aspects 13 and 14, where the at least one UE-selected bandwidth portion of the downlink BWP includes a single UE-selected bandwidth portion corresponding to the entire downlink BWP.

Aspect 22 is the method of any of aspects 13 and 14, where the at least one UE-selected bandwidth portion of the downlink BWP includes a plurality of UE-selected bandwidth portions in the downlink BWP, and the CSI report includes a respective CQI for each UE-selected bandwidth portion in the plurality of UE-selected bandwidth portions.

Aspect 23 is the method of aspect 22, further including: receiving indications of a plurality of bandwidths corresponding to the plurality of UE-selected bandwidth portions in the downlink BWP from the UE.

Aspect 24 is the method of any of aspects 13 to 23, where the downlink BWP is associated with a full-duplex operation.

Aspect 25 is an apparatus for wireless communication including at least one processor coupled to a memory and, based at least in part on information stored in the memory, the at least one processor is configured to implement a method as in any of aspects 1 to 24.

Aspect 26 may be combined with aspect 25 and further includes a transceiver coupled to the at least one processor.

Aspect 27 is an apparatus for wireless communication including means for implementing any of aspects 1 to 24.

Aspect 28 is a non-transitory computer-readable storage medium storing computer executable code, where the code when executed by a processor causes the processor to implement any of aspects 1 to 24.

Various aspects have been described herein. These and other aspects are within the scope of the following claims.

What is claimed is:

1. An apparatus for wireless communication at a user equipment (UE), comprising:
a memory; and
at least one processor coupled to the memory and, based at least in part on information stored in the memory, the at least one processor is configured to:
receive a channel state information-reference signal (CSI-RS) from a network node; and
transmit a channel state information (CSI) report corresponding to at least one UE-selected bandwidth portion of a downlink bandwidth part (BWP) to the network node based on the CSI-RS.

2. The apparatus of claim 1, wherein the CSI report includes at least one channel quality indicator (CQI) for the at least one UE-selected bandwidth portion of the downlink BWP.

3. The apparatus of claim 1, wherein the at least one UE-selected bandwidth portion of the downlink BWP corresponds to at least one downlink sub-band associated with a UE-selected downlink sub-band configuration in a plurality of usable downlink sub-band configurations.

4. The apparatus of claim 3, wherein the at least one UE-selected bandwidth portion of the downlink BWP includes a plurality of downlink sub-bands associated with the UE-selected downlink sub-band configuration.

5. The apparatus of claim 3, the at least one processor being configured to:
transmit, prior to transmitting the CSI report, an indication of the UE-selected downlink sub-band configuration to the network node.

6. The apparatus of claim 3, wherein the plurality of usable downlink sub-band configurations is preconfigured.

7. The apparatus of claim 3, wherein the plurality of usable downlink sub-band configurations is configured based on radio resource control (RRC) signaling from the network node.

8. The apparatus of claim 3, wherein each usable downlink sub-band configuration in the plurality of usable downlink sub-band configurations is associated with a specified number of sub-bands of a specified sub-band size.

9. The apparatus of claim 1, wherein the at least one UE-selected bandwidth portion of the downlink BWP includes a single UE-selected bandwidth portion corresponding to the entire downlink BWP.

10. The apparatus of claim 1, wherein the at least one UE-selected bandwidth portion of the downlink BWP includes a plurality of UE-selected bandwidth portions in the downlink BWP, and the CSI report includes a respective channel quality indicator (CQI) for each UE-selected bandwidth portion in the plurality of UE-selected bandwidth portions.

11. The apparatus of claim 10, the at least one processor being further configured to:
transmit indications of a plurality of bandwidths corresponding to the plurality of UE-selected bandwidth portions in the downlink BWP to the network node.

12. The apparatus of claim 1, wherein the downlink BWP is associated with a full-duplex operation.

13. The apparatus of claim 1, further comprising a transceiver coupled to the at least one processor, the transceiver being configured to receive the CSI-RS and transmit the CSI report.

14. A method of wireless communication at a user equipment (UE), comprising:
receiving a channel state information-reference signal (CSI-RS) from a network node; and
transmitting a channel state information (CSI) report corresponding to at least one UE-selected bandwidth portion of a downlink bandwidth part (BWP) to the network node based on the CSI-RS.

15. The method of claim 14, wherein the CSI report includes at least one channel quality indicator (CQI) for the at least one UE-selected bandwidth portion of the downlink BWP.

16. An apparatus for wireless communication at a network node, comprising:
a memory; and
at least one processor coupled to the memory and, based at least in part on information stored in the memory, the at least one processor is configured to:
transmit a channel state information-reference signal (CSI-RS) to a user equipment (UE); and
receive a channel state information (CSI) report corresponding to at least one UE-selected bandwidth portion of a downlink bandwidth part (BWP) from the UE based on the CSI-RS.

17. The apparatus of claim 16, wherein the CSI report includes at least one channel quality indicator (CQI) for the at least one UE-selected bandwidth portion of the downlink BWP.

18. The apparatus of claim 16, wherein the at least one UE-selected bandwidth portion of the downlink BWP corresponds to at least one downlink sub-band associated with a UE-selected downlink sub-band configuration in a plurality of usable downlink sub-band configurations.

19. The apparatus of claim 18, wherein the at least one UE-selected bandwidth portion of the downlink BWP includes a plurality of downlink sub-bands associated with the UE-selected downlink sub-band configuration.

20. The apparatus of claim 18, the at least one processor being configured to:
receive, prior to receiving the CSI report, an indication of the UE-selected downlink sub-band configuration from the UE.

21. The apparatus of claim 18, wherein the plurality of usable downlink sub-band configurations is preconfigured.

22. The apparatus of claim 18, wherein the plurality of usable downlink sub-band configurations is configured based on radio resource control (RRC) signaling from the network node.

23. The apparatus of claim 18, wherein each usable downlink sub-band configuration in the plurality of usable downlink sub-band configurations is associated with a specified number of sub-bands of a specified sub-band size.

24. The apparatus of claim 16, wherein the at least one UE-selected bandwidth portion of the downlink BWP includes a single UE-selected bandwidth portion corresponding to the entire downlink BWP.

25. The apparatus of claim 16, wherein the at least one UE-selected bandwidth portion of the downlink BWP includes a plurality of UE-selected bandwidth portions in the downlink BWP, and the CSI report includes a respective channel quality indicator (CQI) for each UE-selected bandwidth portion in the plurality of UE-selected bandwidth portions.

26. The apparatus of claim 25, the at least one processor being further configured to:
receive indications of a plurality of bandwidths corresponding to the plurality of UE-selected bandwidth portions in the downlink BWP from the UE.

27. The apparatus of claim 16, wherein the downlink BWP is associated with a full-duplex operation.

28. The apparatus of claim 16, further comprising a transceiver coupled to the at least one processor, the transceiver being configured to transmit the CSI-RS and receive the CSI report.

29. A method of wireless communication at a network node, comprising:
transmitting a channel state information-reference signal (CSI-RS) to a user equipment (UE); and
receiving a channel state information (CSI) report corresponding to at least one UE-selected bandwidth portion of a downlink bandwidth part (BWP) from the UE based on the CSI-RS.

30. The method of claim 29, wherein the CSI report includes at least one channel quality indicator (CQI) for the at least one UE-selected bandwidth portion of the downlink BWP.
